(19) United States
(12) Patent Application Publication
(10) Pub. No.: US 2022/0051557 A1
(43) Pub. Date: Feb. 17, 2022

(54) WARNING NOTIFICATION SYSTEM, WARNING NOTIFICATION METHOD, AND WARNING NOTIFICATION PROGRAM

(71) Applicant: Toyota Jidosha Kabushiki Kaisha, Toyota-shi Aichi-ken (JP)

(72) Inventors: Issei Sakazaki, Nagoya-shi Aichi-ken (JP); Yusuke Nakano, Nagoya-shi Aichi-ken (JP)

(21) Appl. No.: 17/397,409

(22) Filed: Aug. 9, 2021

(30) Foreign Application Priority Data
Aug. 11, 2020 (JP) 2020-135658

(51) Int. Cl. G08G 1/005; G06K 9/00; G08G 1/01; G08G 1/04

(52) U.S. Cl. CPC G08G 1/005; G08G 1/04; G08G 1/0116; G06K 9/00785

(57) ABSTRACT

A warning notification server includes a storage unit configured to store a plurality of pieces of attribute information about moving entities and a plurality of notification devices for warnings while associating them with each other, a detection unit (an object recognition unit) configured to detect, from an image obtained by photographing a traffic environment, attribute information in a moving entity shown in the image, a specification unit configured to specify the notification device associated with the detected attribute information from the storage unit when a degree of danger of the moving entity in the traffic environment is equal to or larger than a predetermined value, and a notification unit configured to notify the moving entity of a warning by using the specified notification device.

### CROSS REFERENCE TO RELATED APPLICATIONS

This application is based upon and claims the benefit of priority from Japanese patent application No. 2020-135658, filed on Aug. 11, 2020, the disclosure of which is incorporated herein in its entirety by reference.

### BACKGROUND

The present disclosure relates to a warning notification system, a warning notification method, and a warning notification program.

Japanese Unexamined Patent Application Publication No. 2015-185075 discloses a technique related to a streetlamp system which is installed on a roadway or a sidewalk beside the roadway, and alerts pedestrians. The aforementioned streetlamp system warns a pedestrian who has been detected based on the state of surrounding of the roadway and the like when it is predicted that the pedestrian will enter the roadway beyond the boundary between the roadway and the sidewalk.

### SUMMARY

However, in the technique disclosed in Japanese Unexamined Patent Application Publication No. 2015-185075, there is a problem that some pedestrians are less likely to notice the warning than other pedestrians. This is because, in the technique disclosed in Japanese Unexamined Patent Application Publication No. 2015-185075, only one type of a warning method is used.

The present disclosure has been made in order to solve such a problem, and is to alert a moving entity in a traffic environment by using appropriate notification device according to an attribute(s) (e.g., a characteristic(s)) of a pedestrian or the like.

A first exemplary aspect is a warning notification system including: a storage unit configured to store a plurality of pieces of attribute information about moving entities and a plurality of notification devices for providing warnings while associating them with each other; a detection unit configured to detect, from an image obtained by photographing a traffic environment, attribute information in a moving entity shown in the image; a specification unit configured to specify the notification device associated with the detected attribute information from the storage unit when a degree of danger of the moving entity in the traffic environment is equal to or larger than a predetermined value; and a notification unit configured to notify the moving entity of a warning by using the specified notification device.

As described above, in this aspect, notification device is specified based on an attribute of a moving entity obtained by analyzing a taken image (e.g., a photographed image or a filmed image) by using a database in which a plurality of pieces of attribute information of moving bodies are associated with a plurality of warning notification device, so that a warning can be provided by using notification device suitable for the moving entity in the actual traffic environment. Therefore, it is possible to effectively alert a person which is included in the moving entity (i.e., is a type of the moving entity in this specification).

Further, the notification device may include a type of notification apparatus, the specification unit may specify the type of the notification apparatus associated with the attribute information from the storage unit, and the notification unit may provide the warning notification by using the notification apparatus of the specified type. For example, it is possible to notify a pedestrian wearing earphones of a warning by using a laser apparatus instead of using a speaker as the notification apparatus.

Further, the detecting unit may further detect an orientation of a face or a direction of a line of sight in the moving entity, the specification unit may further specify a notifying direction according to the detected orientation of the face or the detected direction of the line of sight, and the notification unit may provide the warning notification in the specified notifying direction. In this way, the warning notification can be provided toward the traveling direction of the moving entity, so that the person, which is included in the moving entity, is more likely to notice the warning.

Further, when the specified notification device corresponds to a plurality of notification apparatuses, the specification unit may specify, among the plurality of notification apparatuses, one located in a direction indicated by the detected orientation of the face or the detected direction of the line of sight, and the notification unit may provide the warning notification by using the specified apparatus. In this way, the person, which is included in the moving entity, is likely to notice the warning more naturally.

Further, the notification device may include a curbstone that is provided in the traffic environment and embedded with a luminous element, the luminous element embedded in the curbstone may be connected to the warning notification system through a network, and when the specified apparatus is the curbstone, the notification unit may output a light-emitting instruction to the luminous element through the network. In this way, it is possible to provide a warning to the person, which is included in the moving entity, so that he/she is likely to visually notice the waning.

Further, the warning notification system may further include an acquisition unit configured to acquire, from a portable terminal possessed by the moving entity, a communication mode of the warning notification and position information of the portable terminal, the detection unit may further detect the position of the moving entity shown in the image, when the degree of the danger of the moving entity in the traffic environment is equal to or larger than the predetermined value, the specification unit may specify a position of the moving entity in the traffic environment based on the detected position, when the specified position and a position indicated by the acquired position information are within a predetermined range, the portable terminal may be specified as the notification device, and the notification unit may provide the warning notification according to the acquired communication mode by using the portable terminal. In this way, it is possible to provide the warning more appropriately in the way desired by the person, which is included in the moving entity.

Further, the moving entity may include at least one of a pedestrian, a wheelchair, and a bicycle. As a result, it is possible to easily ensure the safety of the person, which is included in the moving entity.

A second exemplary aspect is a warning notification method including: a detection step of detecting, by a computer, attribute information in a moving entity shown in an image from the image, the image being obtained by photographing a traffic environment; a determination step of determining, by the computer, a degree of danger of the moving entity in the traffic environment; a specifying step of specifying, by the computer, notification device associated with the detected attribute information from a storage unit when the degree of the danger of the moving entity in the traffic environment is equal to or larger than a predetermined value, the storage unit storing a plurality of pieces of attribute information and a plurality of notification devices for providing warnings while associating them with each other; and a notification step of notifying, by the computer, the moving entity of a warning by using the specified notification device.

Further, the notification device may include a type of notification apparatus, in the specification step, the type of the notification apparatus associated with the attribute information may be specified from the storage unit, and in the notification step, the warning notification may be provided by using the notification apparatus of the specified type.

A third exemplary aspect is a warning notification program for causing a computer to perform: a detection step of detecting attribute information in a moving entity shown in an image from the image, the image being obtained by photographing a traffic environment; a determination step of determining a degree of danger of the moving entity in the traffic environment; a specifying step of specifying notification device associated with the detected attribute information from a storage unit when the degree of the danger of the moving entity in the traffic environment is equal to or larger than a predetermined value, the storage unit storing a plurality of pieces of attribute information and a plurality of notification devices for providing warnings while associating them with each other; and a notification step of notifying the moving entity of a warning by using the specified notification device.

Even in the second and third aspects, advantageous effects similar to those in the first embodiment can be expected.

According to the present disclosure, it is possible to warn a moving entity in a traffic environment by using appropriate notification device according to the attribute of a pedestrian or the like.

The above and other objects, features and adventures of the present disclosure will become more fully understood from the detailed description given below and the accompanying drawings which are given by way of illustration only, and those are not to be considered as limiting the present disclosure.

### BRIEF DESCRIPTION OF DRAWINGS

FIG. 1 is a block diagram showing an overall configuration of a warning notification system according to a first embodiment;

FIG. 2 is a block diagram showing a configuration of a warning notification server according to the first embodiment;

FIG. 3 is a flowchart showing a flow of a warning notification method according to the first embodiment; FIG. 4 shows an example in which a pedestrian is detected according to the first embodiment;

FIG. 5 shows an example of a warning notification to a pedestrian according to the first embodiment;

FIG. 6 shows an example of a warning notification to a pedestrian according to the first embodiment;

FIG. 7 is a block diagram showing a configuration of a warning notification server according to a second embodiment;

FIG. 8 is a block diagram showing an overall configuration of a warning notification system according to a third embodiment;

FIG. 9 is a block diagram showing a configuration of a warning notification server according to the third embodiment; and

FIG. 10 is a flowchart showing a flow of a warning notification method according to the third embodiment.

### DESCRIPTION OF EMBODIMENTS

Specific embodiments to which the present disclosure including the above-described aspects is applied are described hereinafter in detail with reference to the drawings. The same reference numerals (or symbols) are assigned to the same components throughout the drawings and duplicated explanations are omitted as appropriate for clarifying the explanation.

### First Embodiment

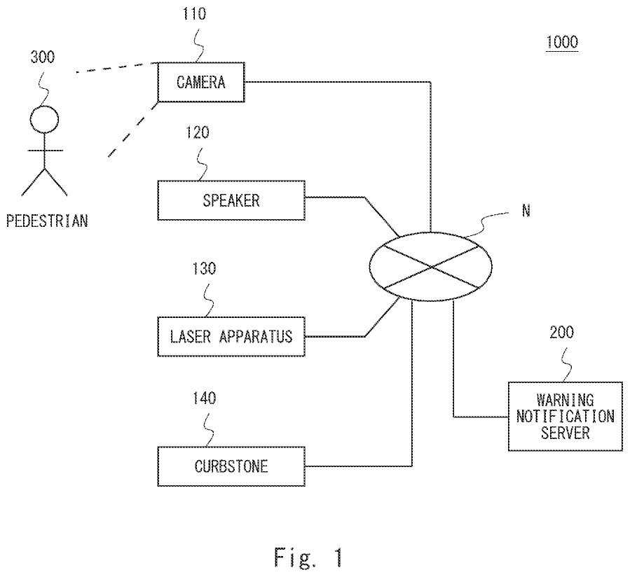

FIG. 1 is a block diagram showing an overall configuration of a warning notification system 1000 according to a first embodiment. The warning notification system 1000 is an information system that notifies a pedestrian 300 present in a certain traffic environment (such as in a sidewalk near an intersection) of a warning when the pedestrian 300 is in danger of a traffic accident or the like. The warning notification system 1000 includes a camera 110, a speaker 120, a laser apparatus 130, a curbstone 140, and a warning notification server 200. Note that the camera 110, the speaker 120, the laser apparatus 130, the curbstone 140, and the warning notification server 200 are connected to each other through a network N so that they can communicate with each other. Note that the network N is a communication line network such as the Internet, an intranet, a mobile-phone network, and a LAN (Local Area Network).

The pedestrian 300 is a person who walks on a sidewalk, in a pedestrian crossing, or the like in the aforementioned traffic environment, and is an example of a moving entity.

The camera 110 is a photographing apparatus (e.g., a filming apparatus) installed in the traffic environment, and takes video images of a predetermined area to be monitored (such as an intersection and its surroundings) and transmits the taken video image to the warning notification server 200 through the network N. The taken video image is a set of taken images (e.g., photographed images or filmed images) in chronological order, and it is assumed that each of the taken images includes a pedestrian(s) 300, an automobile(s) or the like traveling at or near an intersection.

The speaker 120, the laser apparatus 130, and the curbstone 140 are examples of notification apparatuses installed in the traffic environment. Note that although two or more types of notification apparatuses may be provided in this embodiment, the only requirement is that at least two notification apparatuses of the same type should be provided at different places.

The speaker 120 outputs a sound in response to an instruction that is sent from the warning notification server 200 through the network N. The speaker 120 may be a directional speaker. In such a case, the speaker 120 outputs a sound in a direction corresponding to the direction of the output included in the instruction from the warning notification server 200.

The laser apparatus 130 emits laser light in response to an instruction that is sent from the warning notification server 200 through the network N. In particular, when an output direction is included in the instruction from the warning notification server 200, the laser apparatus 130 outputs (i.e., emits) laser light in the indicated direction.

The curbstone 140 is a block (e.g., a concrete block) installed at the boundary between the sidewalk and the roadway, and is embedded with a luminous element(s). Further, the luminous element of the curbstone 140 is connected to the warning notification server 200 through the network N. The luminous element emits light according to a light-emitting instruction that is sent from the warning notification server 200 through the network N.

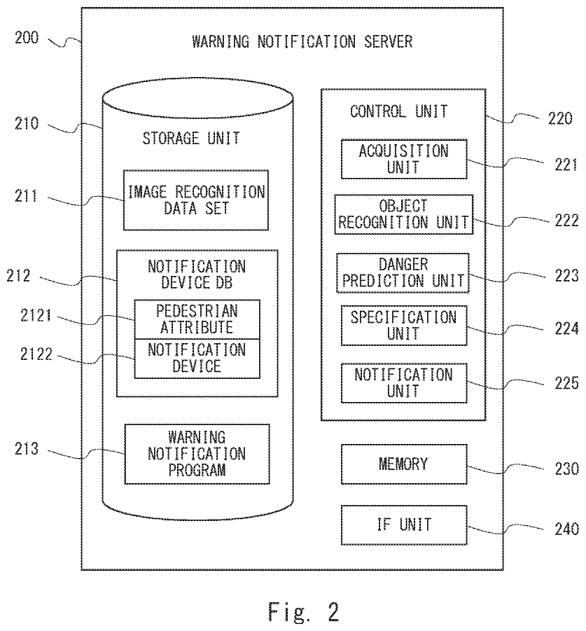

The warning notification server 200 is composed of at least one information processing apparatus for providing a predetermined warning notification to a pedestrian 300 in the traffic environment when the pedestrian 300 is in danger of a traffic accident or the like. FIG. 2 is a block diagram showing a configuration of the warning notification server 200 according to the first embodiment. Note that, in FIG. 2, an internal configuration of the warning notification server 200 in the case where it is implemented by one computer apparatus is shown by functional blocks.

The warning notification server 200 includes a storage unit 210, a control unit 220, a memory 230, and an IF (InterFace) unit 240. The storage unit 210 is a nonvolatile storage device such as a hard disk drive and a flash memory. The storage unit 210 stores at least an image recognition data set 211, a notification device DB (DataBase) 212, and a warning notification program 213.

The image recognition data set 211 includes a set of comparison images used for image recognition (object recognition). The image recognition data set 211 includes, for example, a set of images of pedestrians of different ages, different genders, different types of body wear, different orientations of faces, and different lines of sight. The body wear is, for example, sunglasses, earphones, hearing aids, canes, and the like, but is not limited to these items.

The notification device DB 212 is a database in which pedestrian attributes 2121, which are a plurality of pieces of attribute information of pedestrians, and a plurality of notification devices 2122 for warnings are managed (i.e., stored) while being associated with each other. The pedestrian attribute 2121 is information indicating, for example, a visually impaired person, an earphone user (including an audibly handicapped person), or/and an elderly person, and is a part of a result of recognition obtained by performing object recognition on a taken image(s). The notification device 2122 is a type of notification apparatus, a level of an output produced by the notification apparatus, or the like. The notification device DB 212 includes, for example, the following associative array (Pedestrian attribute: Notification device).

{Visually impaired person: speaker, Earphone user: Laser apparatus Elderly person: Power level higher than normal level Other: Curbstone}

The warning notification program 213 is a computer program in which the processes of a warning notification method according to the first embodiment are implemented.

The memory 230 is a volatile storage device such as a RAM (Random Access Memory), and serves as a storage area for temporarily holding information during the operation of the control unit 220.

The IF unit 240 is an interface for receiving/outputting data from/to entities located outside the warning notification server 200. The IF unit 240 is a communication circuit for performing at least communication through the network N.

The control unit 220 is a processor that controls each component of the warning notification server 200. The control unit 220 loads the warning notification program 213 from the storage unit 210 into the memory 230, and executes the loaded warning notification program 213. In this way, the control unit 220 implements the functions of an acquisition unit 221, an object recognition unit 222, a danger prediction unit 223, a specification unit 224, and a notification unit 225, all of which will be described later.

The acquisition unit 221 acquires taken video images that are obtained as the camera 110 photographs (e.g., films) the traffic environment on an image-by-image basis.

The object recognition unit 222 performs object recognition on the acquired image by using the image recognition data set 211, and acquires a result of the recognition (hereinafter also referred to as a recognition result). For example, the object recognition unit 222 may use a known object recognition engine that operates while referring to the image recognition data set 211. In such a case, the object recognition unit 222 inputs (i.e., supplies) the acquired image to the object recognition engine and acquires a recognition result as an output thereof. Note that the recognition result includes the positions of a pedestrian(s) 300 and an automobile(s) in the traffic environment, the orientation of the face of the pedestrian 300 or the direction of the line of sight thereof, the attribute of the pedestrian 300, the moving directions of the pedestrian 300 and the automobile, the moving speeds of the pedestrian 300 and the automobile, and the like. Therefore, the object recognition unit 222 can be considered to be an example of a detection unit that detects attribute information in a moving entity shown in an image obtained by photographing (or filming) the traffic environment from that image. Further, it can be considered that the object recognition unit 222 detects the orientation of the face or the direction of the line of sight of the pedestrian 300.

The danger prediction unit 223 predicts a degree of danger of the pedestrian 300 in the traffic environment based on the recognition result, and determines whether or not the degree of danger is equal to or larger than a predetermined value. For example, the danger prediction unit 223 calculates a probability of a collision between the pedestrian 300 and the automobile based on the positions, the moving directions, and the moving speeds of them, and determines that the degree of danger is equal to or larger than the predetermined value when the calculated probability of the collision is equal to or larger than a predetermined value.

When the degree of danger of the pedestrian 300 in the traffic environment is equal to or larger than the predetermined value, the specification unit 224 specifies, from the notification device DB 212, notification device 2122 associated with the pedestrian attribute 2121 detected by the object recognition unit 222 (i.e., the pedestrian attribute 2121 included in the recognition result). Specifically, the specification unit 224 specifies the type of the notification apparatus associated with the pedestrian attribute 2121 from the notification device DB 212. Further, the specification unit 224 specifies a notifying direction according to the orientation of the face or the direction of the line of sight included in the recognition result. In particular, when the specified notification device corresponds to a plurality of notification apparatuses, the specification unit 224 specifies, among the plurality of notification apparatuses, one located in the direction indicated by the detected orientation of the face or the direction of the line of sight.

The notification unit 225 notifies the pedestrian 300 of a warning by using the specified notification device. In particular, the notification unit 225 provides a warning notification by using the notification apparatus of the specified type.

Further, when the specified apparatus is the curbstone 140, the notification unit 225 outputs a light-emitting instruction to the luminous element through the network N.

Note that each of the above-described acquisition unit 221, the object recognition unit 222, the danger prediction unit 223, the specification unit 224, and the notification unit 225 may be implemented by dedicated hardware. Further, some or all of the components of each unit may be implemented by a general-purpose or special-purpose circuit (circuitry), a processor or the like, or a combination thereof. They may be formed by a single chip, or may be formed by a plurality of chips connected to each other through a bus. Some or all of the components of each unit may be implemented by a combination of the above-described circuit or the like and a program. Further, as the processor (the control unit 220), a CPU (Central Processing Unit), a GPU (Graphics Processing Unit), an FPGA (field-programmable gate array), or the like may be used. Further, when some or all of the components of the warning notification server 200 are implemented by a plurality of information processing apparatuses, circuits, or the like, the plurality of information processing apparatuses, the circuits, or the like may be disposed in one place or arranged in a distributed manner. For example, the information processing apparatuses, the circuits, and the like may be implemented as a client-server system, a cloud computing system or the like, or a configuration in which the apparatuses or the like are connected to each other through a communication network. Alternatively, the functions of the warning notification server 200 may be provided in the form of SaaS (Software as a Service).

Further, the image recognition data set 211 and the notification device DB 212 may be stored in a storage device located outside the warning notification server 200, or data may be received/output between a storage system, a database system or the like and the warning notification server 200.

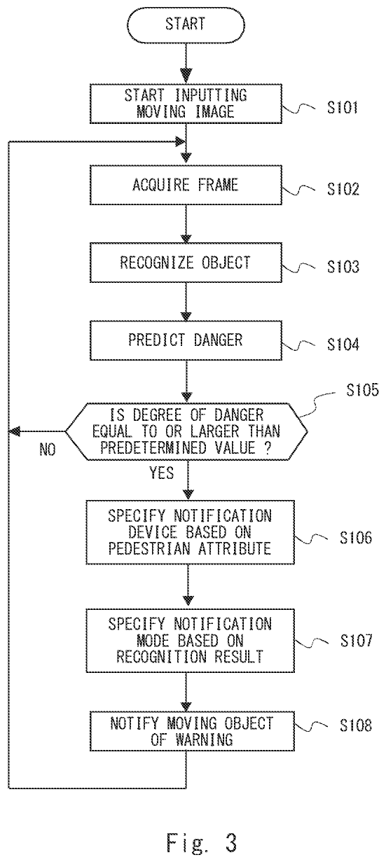

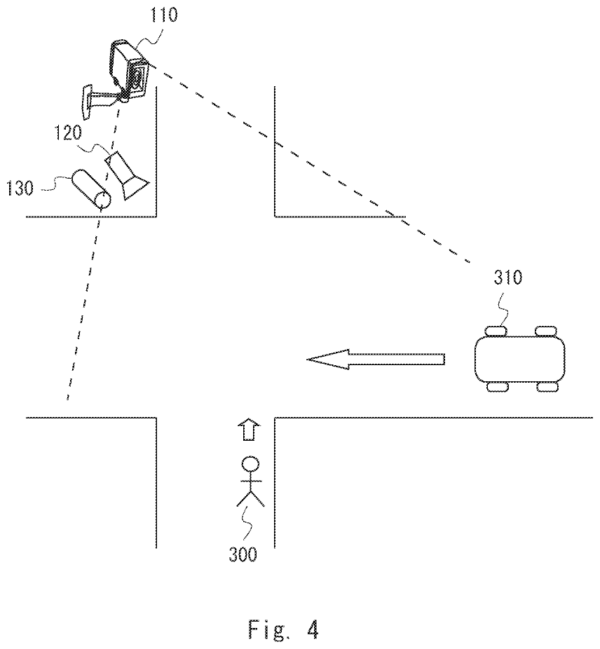

FIG. 3 is a flowchart showing a flow of a warning notification method according to the first embodiment. Firstly, the camera 110 starts photographing (e.g., filming) a traffic environment around an intersection or the like. The camera 110 successively transmits taken video images (e.g., photographed images or filmed images) to the warning notification server 200 through the network N. That is, the camera 110 starts inputting moving images to the warning notification server 200 (S101). In this way, the acquisition unit 221 of the warning notification server 200 acquires images taken by the camera 110. Note that it is assumed that a pedestrian(s) 300 and a traveling automobile(s) are included (e.g., shown) in the taken images.

Next, the acquisition unit 221 acquires the first frame from the taken video images in chronological order (S102). Then, the object recognition unit 222 performs object recognition on the acquired frame image (S103). Further, the object recognition unit 222 acquires a result of the recognition.

Next, the danger prediction unit 223 predicts danger of the pedestrian 300 based on the recognition result (S104). Then, the danger prediction unit 223 determines whether or not the degree of danger of the pedestrian 300 is equal to or larger than a predetermined value (S105).

When it is determined that the degree of danger is equal to or larger than the predetermined value, the specification unit 224 specifies notification device 2122 based on the pedestrian attribute 2121 (S106). Specifically, the specification unit 224 extracts the pedestrian attribute 2121 from the recognition result, and reads out notification device 2122 associated with the extracted pedestrian attribute 2121 from the notification device DB 212. For example, when the pedestrian attribute 2121 is a visually impaired person, the specification unit 224 refers to the notification device DB 212 and specifies a speaker as the notification device 2122. Further, when the pedestrian attribute 2121 is an earphone user, the specification unit 224 refers to the notification device DB 212 and specifies a laser apparatus as the notification device 2122. Further, when the pedestrian attribute 2121 is an elderly person, the specification unit 224 refers to the notification device DB 212 and specifies notification device 2122 so that the output level of a given notification apparatus becomes higher than a normal level. Note that the pedestrian attribute included in the recognition result may be a combination of a plurality of types of attributions. For example, the recognition result may include a visually impaired person and an elderly person as attributes of the pedestrian. In such a case, the specification unit 224 specifies notification device 2122 so that the notification apparatus is a speaker and the output level thereof is set to a value higher than a normal level.

Further, the specification unit 224 specifies a notification mode based on the recognition result (S107). Specifically, the specification unit 224 specifies, as the notification mode, an apparatus used for the notification, an output direction, and the like based on the position of the pedestrian 300 in the image, the orientation of the face or the direction of the line of sight thereof, the moving direction thereof, the moving speed thereof, and the like included in the recognition result. For example, when the curbstone 140 is specified as the notification device in the step S106, the specification unit 224 specifies the direction from the current position of the pedestrian 300, indicated by the orientation of the face or the direction of the line of sight thereof included in the recognition result, and specifies, among a plurality of curbstones, one located in the specified direction as the apparatus used for the notification. Further, when a laser apparatus is specified as the notification device in the step S106, the specification unit 224 specifies, as the output direction, the direction from the current position of the pedestrian 300 included in the recognition result toward the direction indicated by the orientation of the face or the direction of the line of sight.

After that, the notification unit 225 provides a warning notification according to the specified notification mode by using the specified notification device (S108). For example, the notification unit 225 instructs, through the network N, the (specified) speaker 120 to output a warning sound in the (specified) output direction. Alternatively, the notification unit 225 instructs, through the network N, the (specified) laser apparatus to emit laser light in the (specified) output direction. Alternatively, the notification unit 225 provides a light-emitting instruction to the (specified) curbstone through the network N.

After the step S108, or when it is determined that the degree of danger is smaller than the predetermined value in the step S105, the warning notification system returns to the step S102 and continues the process for the next frame.

FIG. 4 shows an example in which a pedestrian 300 is detected according to the first embodiment. In this example, the camera 110, the speaker 120, and the laser apparatus 130 are installed as notification apparatuses. In this case, the camera 110 photographs (e.g., films) an intersection, and it is assumed that the taken image includes a pedestrian 300 walking toward the intersection and an automobile 310 traveling toward the intersection, and that there is a possibility that they collide with each other in several seconds.

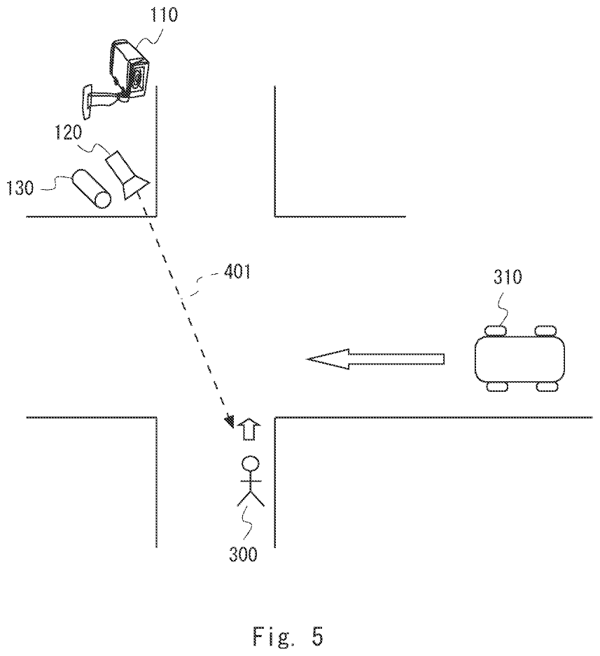

FIG. 5 shows an example of a warning notification for a pedestrian 300 according to the first embodiment. Note that it is assumed that the pedestrian attribute of the pedestrian 300 is a visually impaired person, and therefore a directional speaker 120 is specified as the notification device. Accordingly, the warning notification server 200 instructs the speaker 120 to output a warning sound 401 in the traveling direction of the pedestrian 300. As a result, the pedestrian 300, who is a visually impaired person, can hear the warning sound output toward his/her moving direction and detect (i.e., perceive) his/her own danger.

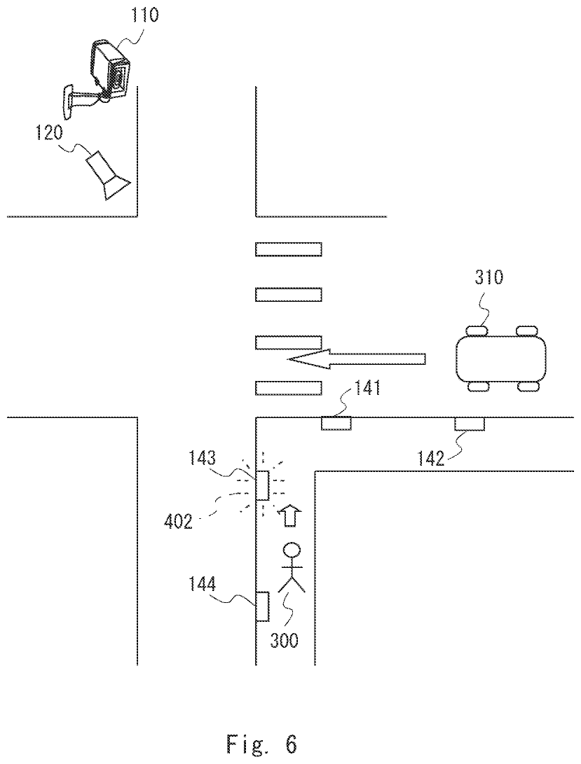

FIG. 6 shows an example of a warning notification to a pedestrian 300 according to the first embodiment. In this example, it is assumed that the pedestrian 300 is walking on a sidewalk, and a speaker 120 and four curbstones 141 to 144 are installed as notification apparatuses. Further, it is assumed that the pedestrian attribute of the pedestrian 300 is an earphone user, and therefore one of the curbstones is specified as the notification device. In this situation, the warning notification server 200 specifies the direction of the line of sight of the pedestrian 300 from the recognition result, and specifies the curbstone 143 as the apparatus for the notification. Then, the warning notification server 200 instructs the curbstone 143 to emit light 402 through the network N. In this way, the pedestrian 300 can detect his/her own danger because of the emission of light by the curbstone 143 which is located at the destination of the line of sight even if the pedestrian 300 is facing downward.

### Second Embodiment

A second embodiment is a modified example of the above-described first embodiment. In first embodiment, a target (an object to be alerted) in object recognition is a pedestrian. In contrast to this, in the second embodiment, the target is a moving entity such as a bicycle or a wheelchair as well as the pedestrian.

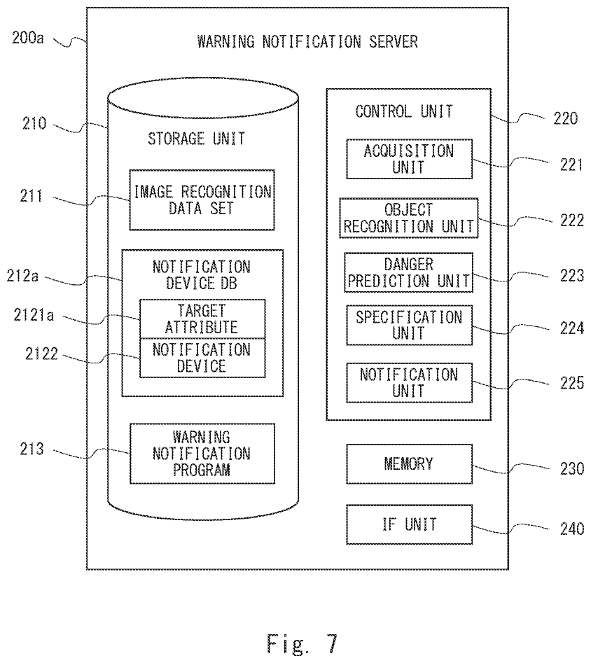

FIG. 7 is a block diagram showing a configuration of a warning notification server 200a according to the second embodiment. Compared to the previously-described warning notification server 200, the notification device DB 212 is replaced by a notification device DB 212a in the warning notification server 200a. The rest of the configuration is similar to that shown in FIG. 2, and therefore the detailed description thereof is omitted.

A plurality of target attributes 2121a and a plurality of notification devices 2122 are associated with each other in the notification device DB 212a. The target attributes 2121a include a bicycle and a wheelchair as well as the above-described pedestrian attributes 2121. Note that the target attributes 2121a may include an automobile or a motorcycle. The notification device 2122 may be associated with a corresponding target attribute 2121a.

It is possible to provide flexible and appropriate warning notifications to various targets by using the above-described notification device DB 212a.

### Third Embodiment

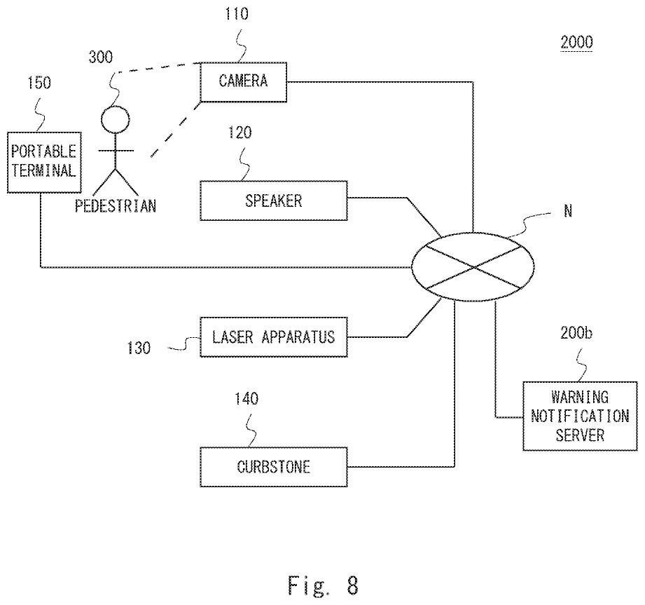

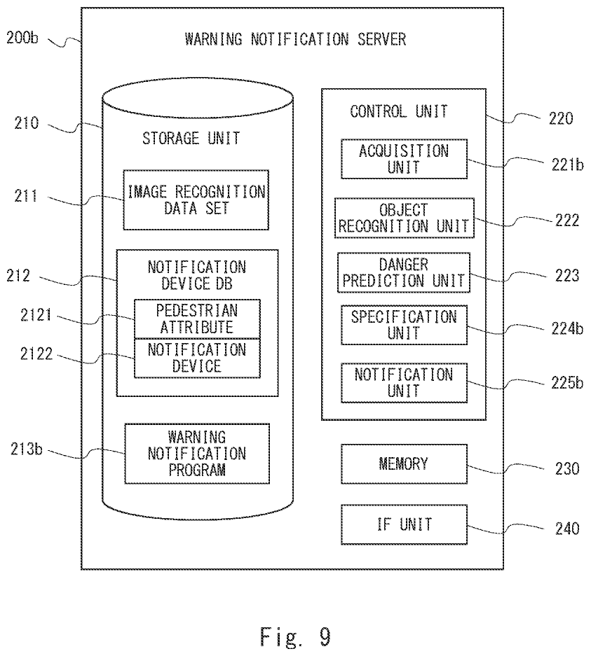

A third embodiment is a modified example of the above-described first embodiment. FIG. 8 is a block diagram showing an overall configuration of a warning notification system 2000 according to the third embodiment. Compared to the above-described warning notification system 1000, the pedestrian 300 possesses a portable terminal 150 and the warning notification server 200 is replaced by a warning notification server 200b in the warning notification system 2000. The rest of the configuration is similar to that shown in FIG. 1, and therefore the detailed description thereof is omitted.

The portable terminal 150 is a portable information terminal such as a mobile telephone terminal and a smart phone, and can communicate with the warning notification server 200b through the network N. It is assumed that an application corresponding to the warning notification system 2000 is operated in the portable terminal 150, and the pedestrian 300 has already logged in to the application. The portable terminal 150 acquires position information of the terminal itself. The position information is, for example, GPS (Global Positioning System) information or the like. Further, in the portable terminal 150, a communication mode for a warning notification is set for the application by an operation performed by the pedestrian 300 or the like. The communication mode is, for example, an e-mail (an electronic mail), an SMS (Short Message Service), or the like. Further, the portable terminal 150 transmits the position information and the communication mode to the warning notification server 200b through the network N. Note that the portable terminal 150 transmits information about the notification destination (hereinafter also referred to as notification destination information) corresponding to the communication mode to the warning notification server 200b together with the aforementioned information. For example, in the case where the communication mode is an e-mail, the notification destination information is an e-mail address of e-mails that the portable terminal 150 can receive, and in the case where the communication mode is an SMS, the notification destination information is a telephone number of the portable terminal 150.

. 9 is a block diagram showing a configuration of the warning notification server 200b according to the third embodiment. Compared to the above-described warning notification server 200, the warning notification program 213, the acquisition unit 221, the specification unit 224, and the notification unit 225 are replaced by a warning notification program 213b, an acquisition unit 221b, a specification unit 224b, and a notification unit 225b, respectively, in the warning notification server 200b.

The warning notification program 213b is a computer program in which the processes of a warning notification method according to the third embodiment are implemented.

The acquisition unit 221b acquires, from the portable terminal 150 possessed by the pedestrian 300, a communication mode for a warning notification and position information of the portable terminal 150. Note that, as described above, the recognition result includes the position of the pedestrian 300. That is, the object recognition unit 222 detects the position of the pedestrian 300 shown in the image.

When the degree of danger of the pedestrian 300 in the traffic environment is equal to or larger than a predetermined value, the specification unit 224b specifies the position of the pedestrian 300 in the traffic environment based on the detected position. Then, when the specified position and the acquired position information are within a predetermined range (i.e., the distance between them is equal to or shorter than a predetermined length), the specification unit 224b specifies the portable terminal 150 as the notification device.

The notification unit 225b provides a warning notification according to the acquired communication mode by using the portable terminal 150.

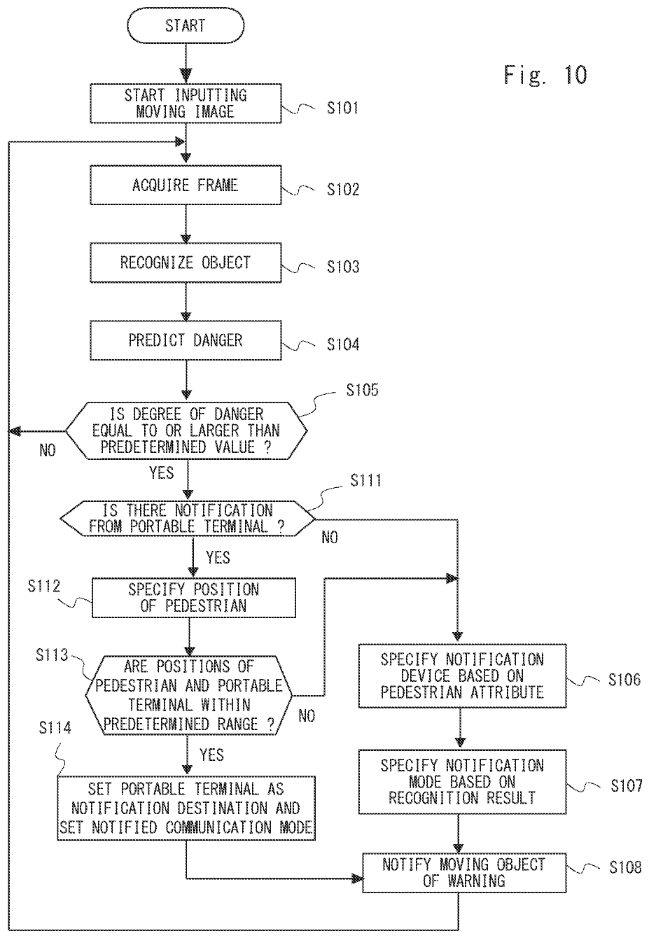

FIG. 10 is a flowchart showing a flow of a warning notification method according to the third embodiment. Note that steps S101 to S105 are similar to those described above with reference to FIG. 3. When it is determined that the degree of danger is equal to or larger than a predetermined value in the step S105, the acquisition unit 221b determines whether or not it has received a notification from the portable terminal 150 (S111). For example, the acquisition unit 221b determines whether or not it has received (acquired) the above-described position information and the communication mode from the portable terminal the user (the pedestrian) of which has already logged in to the application corresponding to the warning notification system 2000. When the specification unit 224b has already received the notification, it specifies the position of the pedestrian 300 (S112). Specifically, the specification unit 224b acquires the position of the pedestrian 300 shown in the image included in the recognition result obtained in the step S103, and specifies the coordinate position in the traffic environment based on the acquired position.

Then, the specification unit 224b determines whether or not the position of the pedestrian 300 and the position of the portable terminal 150 are within a predetermined range (S113) (i.e., the distance between them is equal to or shorter than a predetermined length). When they are within the predetermined range, the specification unit 224b sets the portable terminal 150 as the destination of the notification and sets the notified communication mode as the notification device (S114). After that, the notification unit 225b notifies the portable terminal 150 of a warning through the network N according to the acquired communication mode (S108). In this way, the pedestrian 300 notices the warning by a ring tone or vibrations of the portable terminal 150, and can detect (i.e., perceive) his/her own danger.

Note that when no notification has been received in the step S111, or when they are out of the predetermined range in the step S113, the above-described steps S106 to S108 are performed.

As described above, according to this embodiment, the portable terminal 150 possessed by the pedestrian 300 and the warning notification system 2000 are operated in a linked manner, so that the pedestrian 300 is directly notified of the warning. For example, it is possible to cope with a pedestrian who cannot properly respond to a sound output from a speaker, laser light, or the like, or a pedestrian who wants to specify his/her desired notification mode.

### Other Embodiments

Note that the present disclosure is not limited to the above-described embodiments and they can be modified as desired without departing from the spirit and scope of the present disclosure. For example, although the present disclosure is described as a hardware configuration in the above-described embodiments, the present disclosure is not limited to the hardware configurations. In the present disclosure, arbitrary processes can also be implemented by causing a CPU (Central Processing Unit) to execute a computer program.

In the above-described examples, the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (Compact Disc-Read Only Memory), CD-R (Compact Disc-Recordable), CD-R/W (Compact Disc Rewritable), DVD (Digital Versatile Disc), and semiconductor memories (such as mask ROM, PROM (Programmable ROM), EPROM (Erasable PROM), flash ROM, RAM (Random Access Memory), etc.). Further, the program may be provided to a computer using any type of transitory computer readable media. Examples of transitory computer readable media include electric signals, optical signals, and electromagnetic waves. Transitory computer readable media can provide the program to a computer through a wired communication line (e.g., electric wires, and optical fibers) or a wireless communication line.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A warning notification system comprising:
a storage unit configured to store a plurality of pieces of attribute information about moving entities and a plurality of notification devices for providing warnings while associating them with each other;
a detection unit configured to detect, from an image obtained by photographing a traffic environment, attribute information in a moving entity shown in the image;
a specification unit configured to specify the notification device associated with the detected attribute information from the storage unit when a degree of danger of the moving entity in the traffic environment is equal to or larger than a predetermined value; and
a notification unit configured to notify the moving entity of a warning by using the specified notification device.

2. The warning notification system according to claim 1, wherein
the notification device includes a type of notification apparatus,
the specification unit specifies the type of the notification apparatus associated with the attribute information from the storage unit, and
the notification unit provides the warning notification by using the notification apparatus of the specified type.

3. The warning notification system according to claim 1, wherein
the detecting unit further detects an orientation of a face or a direction of a line of sight in the moving entity,
the specification unit further specifies a notifying direction according to the detected orientation of the face or the detected direction of the line of sight, and
the notification unit provides the warning notification in the specified notifying direction.

4. The warning notification system according to claim 3, wherein
when the specified notification device corresponds to a plurality of notification apparatuses, the specification unit specifies, among the plurality of notification apparatuses, one located in a direction indicated by the detected orientation of the face or the detected direction of the line of sight, and
the notification unit provides the warning notification by using the specified apparatus.

5. The warning notification system according to claim 4, wherein
the notification device includes a curbstone that is provided in the traffic environment and embedded with a luminous element,
the luminous element embedded in the curbstone is connected to the warning notification system through a network, and
when the specified apparatus is the curbstone, the notification unit outputs a light-emitting instruction to the luminous element through the network.

6. The warning notification system according to claim 1, wherein
the warning notification system further comprises an acquisition unit configured to acquire, from a portable terminal possessed by the moving entity, a communication mode of the warning notification and position information of the portable terminal,
the detection unit further detects the position of the moving entity shown in the image,
when the degree of danger of the moving entity in the traffic environment is equal to or larger than the predetermined value, the specification unit specifies a position of the moving entity in the traffic environment based on the detected position,
when the specified position and a position indicated by the acquired position information are within a predetermined range, the portable terminal is specified as the notification device, and
the notification unit provides the warning notification according to the acquired communication mode by using the portable terminal.

7. The warning notification system according to claim 1, wherein the moving entity includes at least one of a pedestrian, a wheelchair, and a bicycle.

8. A warning notification method comprising:
a detection step of detecting, by a computer, attribute information in a moving entity shown in an image from the image, the image being obtained by photographing a traffic environment;
a determination step of determining, by the computer, a degree of danger of the moving entity in the traffic environment;
a specifying step of specifying, by the computer, notification device associated with the detected attribute information from a storage unit when the degree of danger of the moving entity in the traffic environment is equal to or larger than a predetermined value, the storage unit storing a plurality of pieces of attribute information and a plurality of notification devices for providing warnings while associating them with each other; and
a notification step of notifying, by the computer, the moving entity of a warning by using the specified notification device.

9. The warning notification method according to claim 8, wherein
the notification device includes a type of notification apparatus,
in the specification step, the type of the notification apparatus associated with the attribute information is specified from the storage unit, and
in the notification step, the warning notification is provided by using the notification apparatus of the specified type.

10. A non-transitory computer readable medium storing a warning notification program for causing a computer to perform:
a detection step of detecting attribute information in a moving entity shown in an image from the image, the image being obtained by photographing a traffic environment;
a determination step of determining a degree of danger of the moving entity in the traffic environment;
a specifying step of specifying notification device associated with the detected attribute information from a storage unit when the degree of danger of the moving entity in the traffic environment is equal to or larger than a predetermined value, the storage unit storing a plurality of pieces of attribute information and a plurality of notification devices for providing warnings while associating them with each other; and
a notification step of notifying the moving entity of a warning by using the specified notification device.
